(19) United States
(12) Patent Application Publication
(10) Pub. No.: US 2019/0050564 A1
(43) Pub. Date: Feb. 14, 2019

(54) PROTECTION FOR INFERENCE ENGINE AGAINST MODEL RETRIEVAL ATTACK

(71) Applicant: Intel Corporation, Santa Clara, CA (US)

(72) Inventors: Oleg Pogorelik, Lapid (IS); Alex Nayshtut, Gan Yavne (IS); Ran Asher Cohen, Kerem Maharal (IS); Guy Barnhart-Magen, Herzliya (IS)

(73) Assignee: Intel Corporation, Santa Clara, CA (US)

(21) Appl. No.: 16/033,272

(22) Filed: Jul. 12, 2018

(51) Int. Cl. G06F 21/55; G06N 3/04; G06N 3/063; G06N 5/04; G06N 99/00; G06F 21/53

(52) U.S. Cl. CPC G06F 21/554; G06N 3/0472; G06F 21/53; G06N 5/046; G06N 99/005; G06N 3/063

(57) ABSTRACT

An embodiment of a semiconductor package apparatus may include technology to perform run-time analysis of inputs and outputs of a machine learning model of an inference engine, detect an activity indicative of an attempt to retrieve the machine learning model based on the run-time analysis, and perform one or more preventive actions upon detection of the activity indicative of the attempted model retrieval. Other embodiments are disclosed and claimed.

### TECHNICAL FIELD

Embodiments generally relate to machine learning systems. More particularly, embodiments relate to protection for an inference engine against model retrieval attack.

### BACKGROUND

An inference engine may include a machine learning (ML) model. The model may be trained to provide one or more outputs in response to a set of input data. With a suitable model (e.g., a neural network (NN) model) and training, the inference engine may provide artificial intelligence (AI) features such as pattern recognition/prediction, image/object recognition, voice/speech recognition, etc.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of an electronic processing system according to an embodiment;

FIG. 2 is a block diagram of an example of a semiconductor package apparatus according to an embodiment;

FIGS. 3A to 3C are flowcharts of an example of a method of inhibiting a model retrieval according to an embodiment;

FIG. 4 is an illustrative diagram of an example of a model retrieval attack according to an embodiment;

FIGS. 5A and 5B are illustrative diagrams of examples of training and inference data sets according to an embodiment;

FIGS. 6A and 6B are illustrative graphs of count versus confidence for training and inference data sets according to an embodiment;

FIG. 7 is a block diagram of an example of an inference system according to an embodiment;

FIG. 8 is an illustrative diagram of an example of a flow enforcer according to an embodiment;

FIG. 9 is a flowchart of another example of a method of inhibiting a model retrieval according to an embodiment;

FIG. 10 is a block diagram of an example of a computing device according to an embodiment;

FIG. 11 is a block diagram of an example of a processor according to an embodiment; and

FIG. 12 is a block diagram of an example of a computing system according to an embodiment.

### DESCRIPTION OF EMBODIMENTS

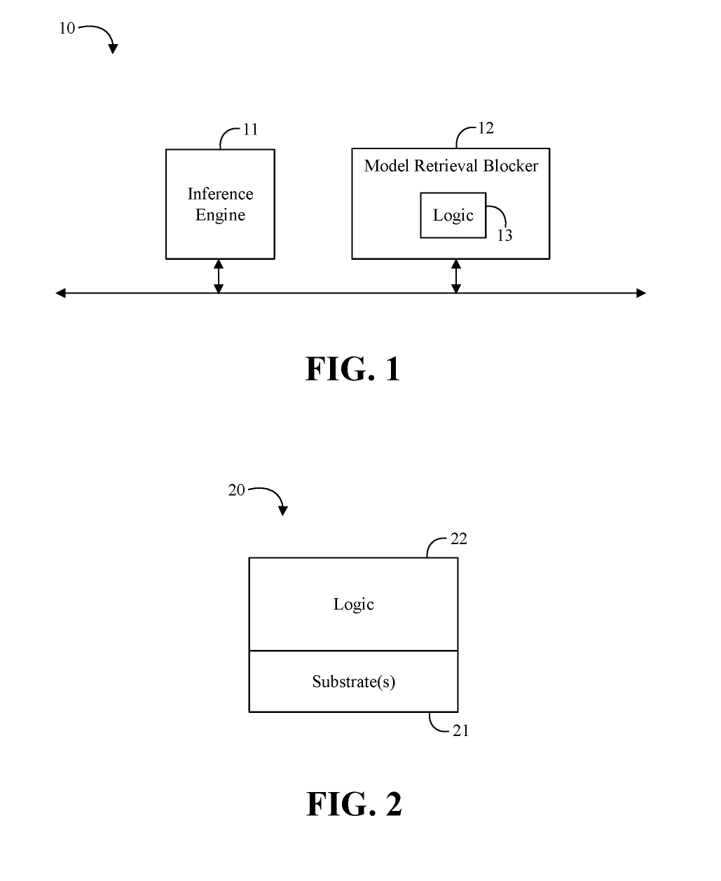

Turning now to FIG. 1, an embodiment of an electronic processing system 10 may include an inference engine 11, and a model retrieval blocker (MRB) 12 communicatively coupled to the inference engine 11. The MRB 12 may include logic 13 to perform run-time analysis of inputs and outputs of a machine learning model of the inference engine 11, detect an activity indicative of an attempt to retrieve the machine learning model based on the run-time analysis, and perform one or more preventive actions upon detection of the activity indicative of the attempted model retrieval. In some embodiments, the logic 13 may be further configured to run one or more of an activity detection and a preventive action at least partly in a secure execution environment. In some embodiments, the logic 13 may be configured to detect an anomaly related to the usage of the machine learning model. For example, the usage anomaly may be based on one or more of similarities between a model retrieval querying pattern and a training pattern, differences in stochastic distributions between feature sets in training and an inference data set, and differences between statistical distributions of the classifications between training data sets and the inference data set. In some embodiments, the logic 13 may also be configured to enforce flow at one or more flow enforcement points in the machine learning model based on a detected anomaly. For example, the one or more preventive actions may include one or more of an interruption of the flow of the machine learning model, an introduction of delay in the execution of the machine learning model, a modification of outputs of the machine learning model, a creation of a log of information related to the model retrieval attempt, and a notification of the model retrieval attempt. In some embodiments, the MRB 12 and/or the logic 13 may be located in, or co-located with, various components, including the inference engine 11 (e.g., on a same die).

Embodiments of each of the above inference engine 11, MRB 12, logic 13, and other system components may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or fixed-functionality logic hardware using circuit technology such as, for example, application specific integrated circuit (ASIC), complementary metal oxide semiconductor (CMOS) or transistor-transistor logic (TTL) technology, or any combination thereof. Embodiments of the inference engine 11 may include one or more of a general purpose processor, a special purpose processor, a central processor unit (CPU), a hardware accelerator, a graphics processor unit (GPU), a controller, a micro-controller, etc.

Alternatively, or additionally, all or portions of these components may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages. For example, persistent storage media, or other system memory may store a set of instructions which when executed by a processor cause the system 10 to implement one or more components, features, or aspects of the system 10 (e.g., the inference engine, the MRB 12, the logic 13, performing the run-time analysis, detecting the activity indicative of the model retrieval attempt, performing the preventive action(s), etc.).

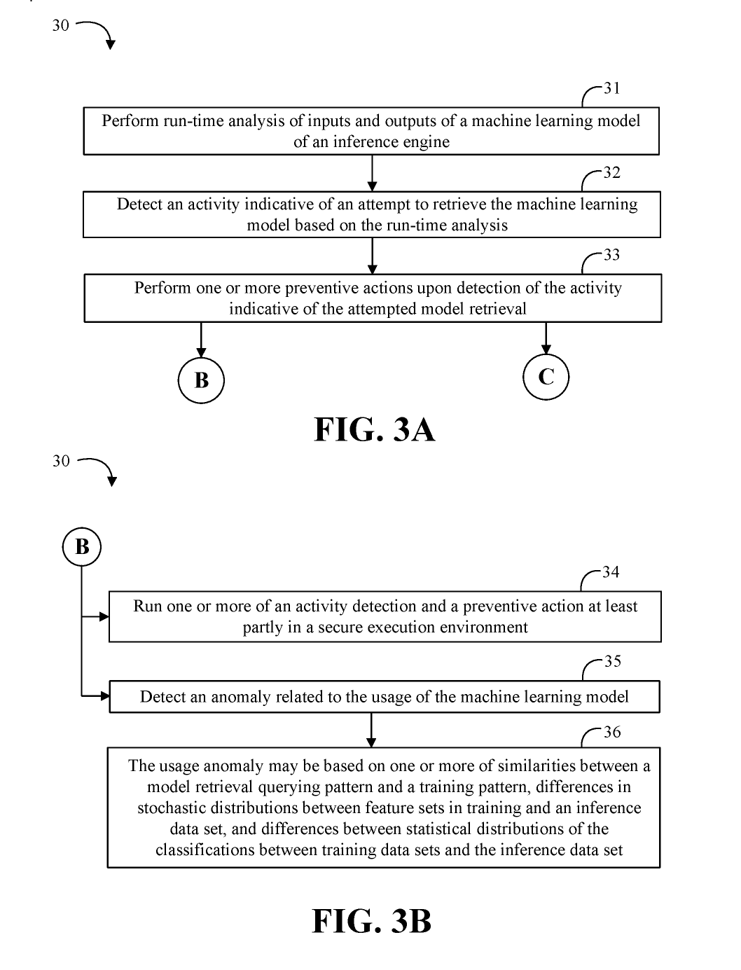

Turning now to FIG. 2, an embodiment of a semiconductor package apparatus 20 may include one or more substrates 21, and logic 22 coupled to the one or more substrates 21, wherein the logic 22 is at least partly implemented in one or more of configurable logic and fixed-functionality hardware logic. The logic 22 coupled to the one or more substrates 21 may be configured to perform run-time analysis of inputs and outputs of a machine learning model of an inference engine, detect an activity indicative of an attempt to retrieve the machine learning model based on the run-time analysis, and perform one or more preventive actions upon detection of the activity indicative of the attempted model retrieval. In some embodiments, the logic 22 may be further configured to run one or more of an activity detection and a preventive action at least partly in a secure execution environment. In some embodiments, the logic 22 may be configured to detect an anomaly related to the usage of the machine learning model. For example, the usage anomaly may be based on one or more of similarities between a model retrieval querying pattern and a training pattern, differences in stochastic distributions between feature sets in training and an inference data set, and differences between statistical distributions of the classifications between training data sets and the inference data set. In some embodiments, the logic 22 may also be configured to enforce flow at one or more flow enforcement points in the machine learning model based on a detected anomaly. For example, the one or more preventive actions may include one or more of an interruption of the flow of the machine learning model, an introduction of delay in the execution of the machine learning model, a modification of outputs of the machine learning model, a creation of a log of information related to the model retrieval attempt, and a notification of the model retrieval attempt. In some embodiments, the logic 22 coupled to the one or more substrates 21 may include transistor channel regions that are positioned within the one or more substrates 21.

Embodiments of logic 22, and other components of the apparatus 20, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

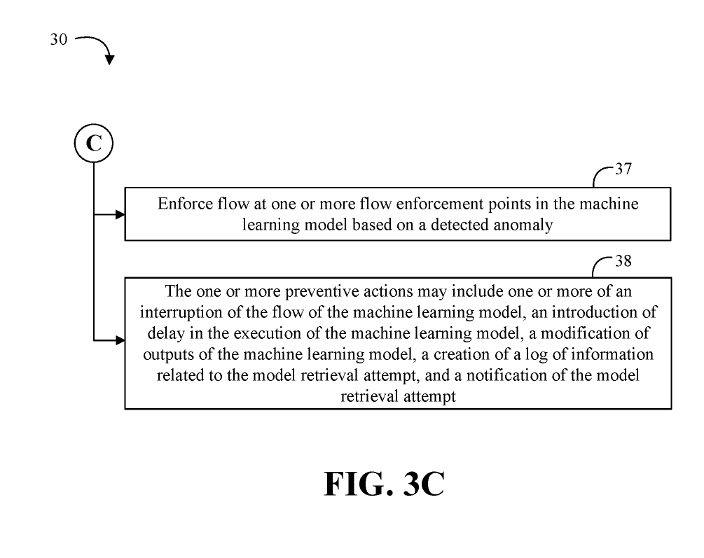

The apparatus 20 may implement one or more aspects of the method 30 (FIGS. 3A to 3C), or any of the embodiments discussed herein. In some embodiments, the illustrated apparatus 20 may include the one or more substrates 21 (e.g., silicon, sapphire, gallium arsenide) and the logic 22 (e.g., transistor array and other integrated circuit/IC components) coupled to the substrate(s) 21. The logic 22 may be implemented at least partly in configurable logic or fixed-functionality logic hardware. In one example, the logic 22 may include transistor channel regions that are positioned (e.g., embedded) within the substrate(s) 21. Thus, the interface between the logic 22 and the substrate(s) 21 may not be an abrupt junction. The logic 22 may also be considered to include an epitaxial layer that is grown on an initial wafer of the substrate(s) 21.

Turning now to FIGS. 3A to 3C, an embodiment of a method 30 of inhibiting model retrieval may include performing run-time analysis of inputs and outputs of a machine learning model of an inference engine at block 31, detecting an activity indicative of an attempt to retrieve the machine learning model based on the run-time analysis at block 32, and performing one or more preventive actions upon detection of the activity indicative of the attempted model retrieval at block 33. Some embodiments of the method 30 may further include running one or more of an activity detection and a preventive action at least partly in a secure execution environment at block 34. Some embodiments of the method 30 may also include detecting an anomaly related to the usage of the machine learning model at block 35. For example, the usage anomaly may be based on one or more of similarities between a model retrieval querying pattern and a training pattern, differences in stochastic distributions between feature sets in training and an inference data set, and differences between statistical distributions of the classifications between training data sets and the inference data set at block 36. Some embodiments of the method 30 may also include enforcing flow at one or more flow enforcement points in the machine learning model based on a detected anomaly at block 37. In any of the embodiments herein, the one or more preventive actions may include one or more of an interruption of the flow of the machine learning model, an introduction of delay in the execution of the machine learning model, a modification of outputs of the machine learning model, a creation of a log of information related to the model retrieval attempt, and a notification of the model retrieval attempt at block 38.

Embodiments of the method 30 may be implemented in a system, apparatus, computer, device, etc., for example, such as those described herein. More particularly, hardware implementations of the method 30 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the method 30 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, the method 30 may be implemented on a computer readable medium as described in connection with Examples 20 to 25 below. Embodiments or portions of the method 30 may be implemented in firmware, applications (e.g., through an application programming interface (API)), or driver software running on an operating system (OS). Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Some embodiments may advantageously provide technology for protecting against a model retrieval attack (MRA) in machine learning (ML) systems. For example, ML/deep learning (DL) systems may be built around models, which may refer to sophisticated software (SW) implementing predictive functions that maps features to a categorical or real-valued output. Models may be derived from the sensitive training data, may be used in security applications, and/or may otherwise have independent commercial value. Accordingly, a ML/DL model may be considered a highly valuable asset to protect against theft. As opposed to some SW that may be protected by running in protected execution environment, some ML/DL models may have additional artificial intelligence (AI) specific vulnerabilities and associated attacks. One example of an ML/DL specific attack includes the MRA.

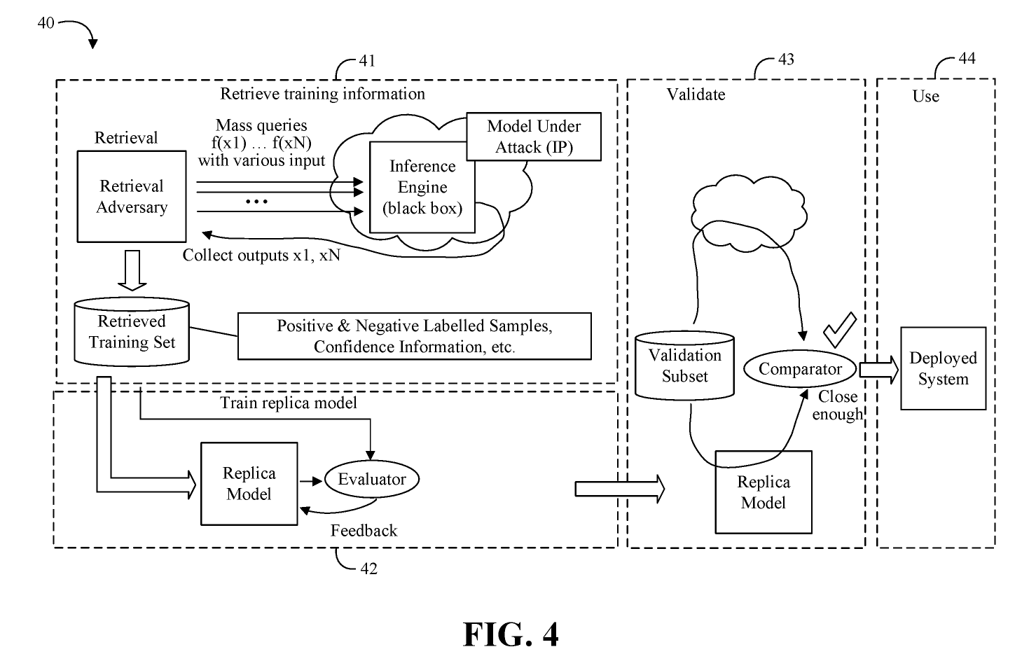

Turning now to FIG. 4, an embodiment of a MRA 40 is shown for purposes of illustration and not limitation. For example, the MRA may include techniques that allow a malicious third party to uncover valuable (e.g., proprietary and/or sensitive) information contained in the training set as well as the model (e.g., configuration settings, weights, topology, etc.) used in an inference engine. At block 41, to extract the model, the attacker generates a representative number of legitimate prediction queries (X1 . . . Xn) and collects corresponding system outputs including classifiers and information rich attributes such as classification confidence level, etc. At block 42, the retrieved information (e.g., a misappropriated training set) is used in training one or more models of the various types to perform the same/similar prediction function. The attacker reconstructs the architecture and characteristics of the model that closely approximates or even matches the original ones. At block 43, a replica model is validated vs. the original model, and at block 44, the replica model and training data is used by malicious third party. For example, a replica inference engine could be sold as a competing product/service and/or replica-based analysis could be used for detecting vulnerabilities in the original model. Advantageously, some embodiments may provide an apparatus to mitigate MRAs in ML and/or DL systems performed by retrieval adversaries.

Some other techniques for mitigating MRAs may include relying on adjustments of the query charges to make the attack (usually requiring thousands of queries) expensive. This technique targets mainly ML as a service (MLaaS) solutions. In the case where a ML/DL product is running on a client platform with full and free of charge access, this technique fails to protect the model. Other techniques may include dropping significant output attributes (such as classification confidence level, recognition probability, etc.) to harden reverse engineering. While raising attack complexity and related effort, this technique might be unacceptable to the customers using these attributes in their inference based decision making. Some embodiments may advantageously augment an inference engine with logic to detect anomalies indicative of a MRA and modify the flow of the model, which may be referred as model retrieval blocker (MRB). Advantageously, the MRB logic may be integrated in the inference operational flow. The MRB may perform run-time analysis of the model inputs and outputs and apply preventive actions upon detecting activities indicating model retrieval attempts.

In some embodiments, the MRB may utilize characteristics of a ML process to detect and/or mitigate a MRA. For example, the MRB may determine if a model retrieval querying pattern is similar to a training pattern (e.g., which may be indicative of a MRA). The MRB may determine if model querying in regular prediction/classification differs from the one used in training (e.g., which may be indicative of a MRA). The MRB may determine if feature sets in training and inference data sets have different stochastic distributions (e.g., which may be indicative of a MRA). The MRB may determine if statistical distributions of the classifications vary significantly per training and inference (e.g., which may be indicative of a MRA).

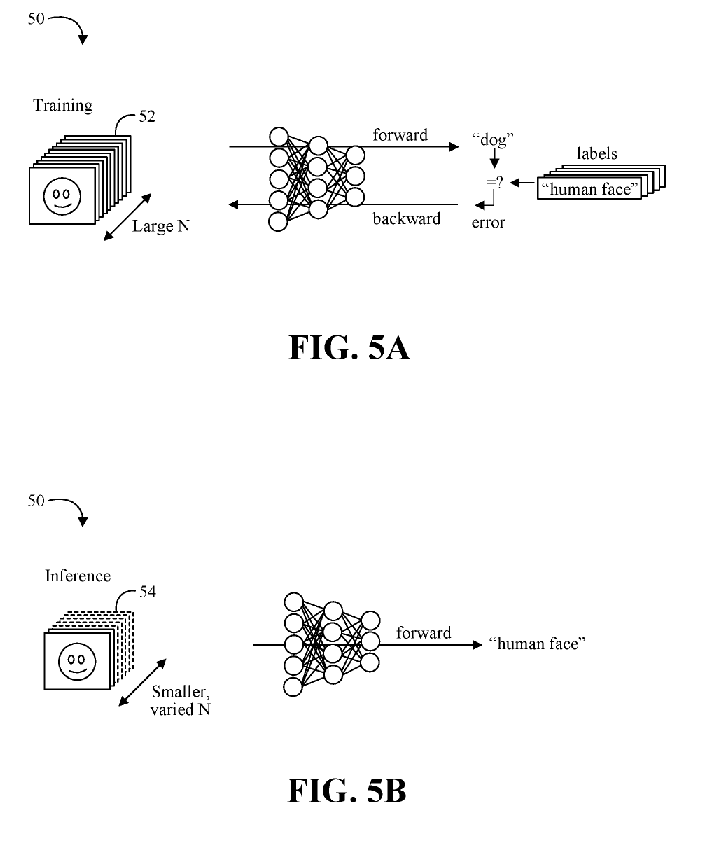

Turning now to FIGS. 5A and 5B, a representative training data set 52 (FIG. 5A) may be compared to a representative inference data set 54 (FIG. 5B). In training, there are generally many inputs, often in large batches. In inference, there are generally fewer inputs used in smaller batches. Accordingly, the presence of an inference data set with many inputs and/or occurring in large batches may be indicative of a MRA.

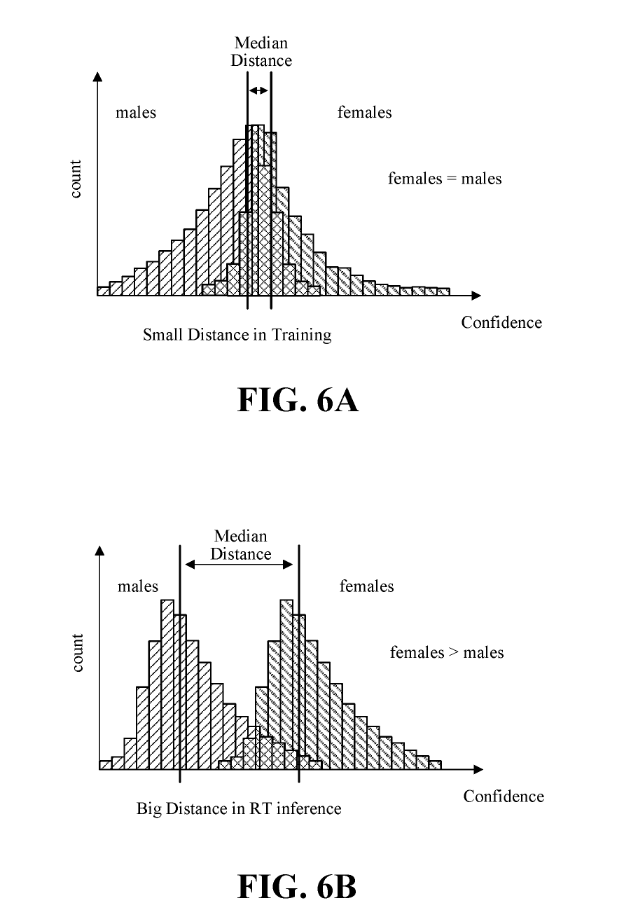

Turning now to FIGS. 6A and 6B, a representative stochastic distribution of example classifications for training data may be compared to a representative stochastic distribution of similar classifications for real-time (RT) inference data. In training (e.g., as well as in a MRA) the developer (e.g., or hacker) will, with high probability, use equal sets of the data (e.g., females=males). As illustrated in FIG. 6A, shapes of the distribution and median distance will be close. In normal RT inference, the distributions will have different shapes with less overlap, and the median distance will be bigger as compared to the training case (e.g., reflecting the fact that, in appropriate groups, the number of males and females generally differs by several percent). Accordingly, the presence of RT inference data with an equal number of classifications, similar distribution shapes, and/or closer median distances may be indicative of a MRA.

The various embodiments described herein may be implemented with any suitable detection technology. The particular detection technology implemented in a particular MRB may be based on one or more of the known techniques such as probabilistic model-building algorithms, and may be selected based on the developer's understanding of what types of inputs were used for training the model in the inference engine, what distribution of data might be expected in training versus during RT inference, etc., on a case-by-case basis. In general terms, some embodiments of a MRB may provide ongoing analysis of the inference inputs and outputs for indications of behavior typical for model retrieval attacks. After suspicious activities are detected, the MRB will apply preventative measures as specified by the developer/manufacturer.

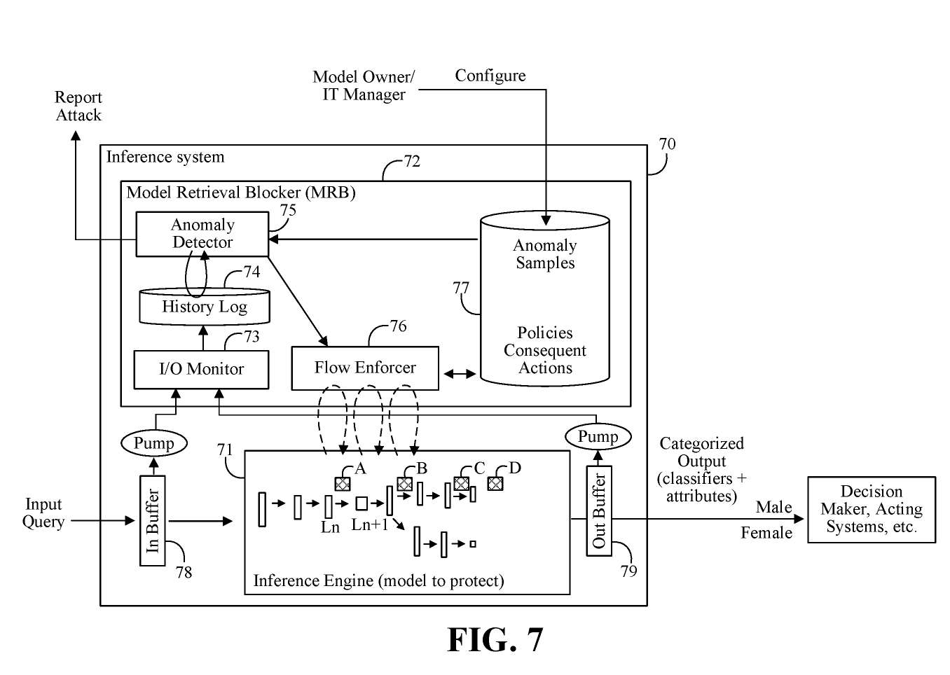

Turning now to FIG. 7, an embodiment of an inference system 70 may include an inference engine 71 communicatively coupled to a MRB 72. The inference engine 71 contains the model to protect (e.g., as illustrated the model contains several neural network layers). In general terms, the MRB 72 may monitor inputs, outputs and inter-node communication within the inference engine 71 in order to detect usage anomalies indicating a MRA. In the case where the MRB 72 decides that the system 70 is under MRA, the MRB 72 may apply one or more of the pre-defined preventive measures such as halt the system 70, introduce additional response latency, modify (e.g., scramble) outputs, notify model provider about attempt to reverse, etc.

In this embodiment, the MRB 72 includes an input/output (IO) monitor 73, a history log store 74, an anomaly detector 75, a flow enforcer 76, and an anomaly sample store 77. The I/O monitor 73 may be configured to monitor inputs and outputs of the inference engine 71. For example, input queries may be stored in an input buffer 78 and provided to both the inference engine 71 and the I/O monitor 73. Similarly, categorized outputs from the inference engine 71 (e.g., classifiers, attributes, etc.) may be stored in an output buffer 79 and provided to both the I/O monitor 73 and to another destination (e.g., the decision maker, the acting system, etc.). The I/O monitor 73 may be coupled to a history log store 74 to store all or some of the monitored I/O. For example, the I/O monitor 73 may collect information about the inputs and outputs, aggregate representative sets (e.g., one year of records), and perform periodic cleanup. The I/O monitor 73 may support queries coming from the anomaly detector 75 to allow detection of short and long-lasting anomalies. During the processing, original and intermediate model inputs as well as outputs may be located in memory. The inference system 70 may support interfaces for pushing the memory data to the I/O monitor 73 at appropriate points of time. In some embodiments, the model owner/IT manager/etc. may configure which of the model inputs and outputs (e.g., key inputs/outputs) will be used for anomaly detection (e.g., considering information density, size and overall performance).

The anomaly detector 75 may include a module which is responsible for run time sampling of the queries and outputs. For example, the anomaly detector 75 may analyze the information from the history log store 74 to detect anomalies in the data which may be indicative of a MRA. In some embodiments, the anomaly detector 75 may compare data in the history log store 74 to information in the anomaly sample store 77 to detect such anomalies. For some types of anomalies, the anomaly detector 75 may transform measurements to stochastic patterns and compare the resulting patterns with pre-configured/stored normal and/or anomaly patterns (e.g., pre-configured and/or stored by the model provider/owner, system administrator, etc.). For example, samples of anomaly and/or normal stochastic distributions may be created by the model provider, user's information technology (IT) manager, etc., in accordance with an expected use case and product usage in specific environment. Every stored/pre-configured anomaly may be associated with a configurable consequent action to apply.

In some embodiments, the detection and prevention mechanisms may be a part of a core operational flow and may be protected with suitable hardware and/or software technology (e.g., trusted execution environment (TEE), run in INTEL SOFTWARE GUARD EXTENSIONS (SGX), etc.). For example, all or portions of the MRB 72 may be protected in a TEE, and/or run in a protected environment such as SGX, TRUSTZONE, etc. Enclaving important parts of the model (e.g., weights, coefficients, etc.) may make model retrieval from memory insufficient for a successful MRA. The system 70 and MRB 72 may have exclusive access to the stochastic samples and policies in the store 77 (e.g., the samples and policies may be as well protected at rest and at run time).

In some embodiments, the inference system 70 (e.g., part of a machine learning system) may be configured to allow the MRB 72 to intercept and modify control flow when needed (e.g., by the flow enforcer 76). For example, the model (e.g., in the inference engine 71) may include one or more flow enforcement points (e.g., points A, B, C, and D in the illustrated example). The flow enforcement points may be implemented as proxy forwarding elements enveloping interfaces of the nodes in the model (e.g., a CNN model). These points may be created in ‘critical’ nodes of the model, such that modification of their configuration (e.g., weights) introduced by the flow enforcer 76 will make accurate model replication impossible. In some embodiments, the flow enforcer 76 may determine appropriate attack preventive actions when an anomaly is reported by the anomaly detector 75. For example, the actions may be a built-in part of the MRB 72 or part of configuration specified by the model owner. In some embodiments, the flow enforcer 76 may cause the inference system 70 to execute one or more of the following non-limiting actions: (1) break the flow, (2) introduce significant delay, (3) modify outputs, (4) create and log informative record, and (5) notify an IT manager or a model owner about the breach.

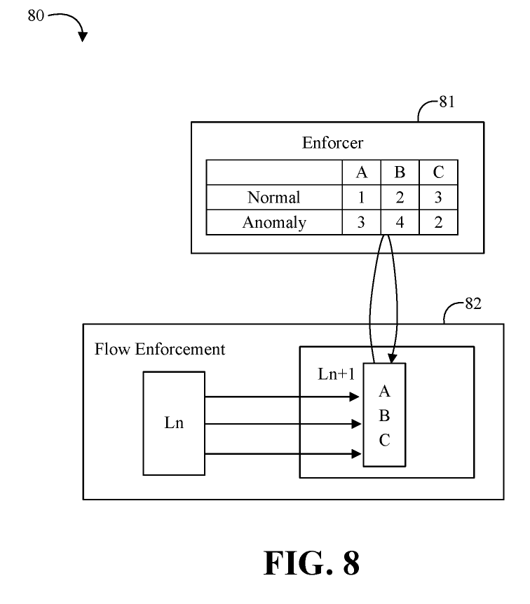

Turning now to FIG. 8, an embodiment of an inference engine 80 may include a flow enforcer 81 communicatively coupled to a model 82. For example, the flow enforcer 81 may be readily substituted for the flow enforcer 76 (FIG. 7), and/or the model 82 may be readily substituted for the model of the inference engine 71 (FIG. 7). Other portions of the inference engine 80 (e.g., the MRB, model details, etc.) are omitted to simplify the illustration. Some embodiments may advantageously utilize flow enforcement points to protect a model, even if the model runs outside of an enclave. For example, an AI inference model such as a neural network may consist of two main components including a neural network topology and weights. In some embodiments, the weights (e.g., fully or partially) may be protected by the flow enforcer 81 that runs in a protected environment (e.g., TEE). In normal conditions, the flow enforcer 81 will release correct weights (e.g., “Normal” weights of 1, 2, and 3 to flow enforcement points A, B, and C, respectively) and inference will perform “regular” classification with the model 82. In case of an anomaly, the flow enforcer 81 will provide the model 82 with wrong weights (e.g., “Anomaly” weights of 3, 4, and 2 to flow enforcement points A, B, and C, respectively) leading to misclassification or confusion in output parameters (e.g., probabilities, confidence, etc.) preventing an attacker from reconstructing an equal clone model.

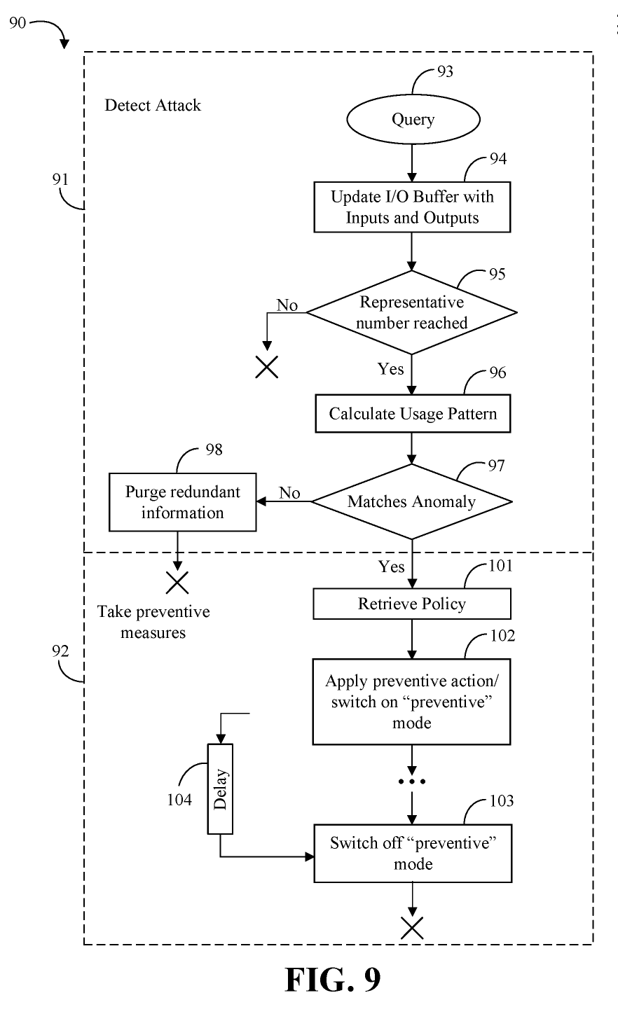

Turning now to FIG. 9, an embodiment of a method 90 of inhibiting a model retrieval may include a MRA preventive operational flow with two phases. A first phase 91 of the method 90 may include attack detection, while a second phase 92 of the method 90 may include attack prevention. The method 90 may start with a model query at block 93, followed by update I/O buffer(s) with inputs and outputs at block 94. For example, an I/O monitor may be triggered on model query. The I/O monitor may buffer query information and/or create query related statistics. Similar actions may happen when an output is provided. After reaching representative number of measurements at block 95, the method 90 may include calculating a usage pattern at block 95 (e.g., an anomaly detector may generate stochastic sample). The method 90 may then determine if the calculated usage pattern matches an anomaly at block 97. If not, the method 90 may purge redundant information at block 98, and no preventive actions may be taken.

If the calculated usage pattern matches an anomaly at block 97, the method 90 may include retrieving a corresponding policy at block 101, and apply the associated preventive actions and/or switch on “preventive mode” at block 102. For example, when a sample result matches one of the known model retrieval attack patterns or significantly differs from a normal expected usage pattern, the anomaly detector may pick up one or more of the associated activities specified in appropriate attack related policies and forward it for execution by the flow enforcer(s). In some embodiments, the flow enforcer(s) will cause the inference engine to execute one or more of actions including breaking the flow, introducing significant delay, modifying outputs, creating and logging and informative record, notifying an IT manager and/or a model owner about the breach, etc. The attack prevention phase 92 may last until being switched off at block 103 by, for example, being manually switched off by authorized personnel, or (as shown in FIG. 9) after pre-defined timeout period at block 104.

Advantageously, some embodiments may provide an inference engine with a block MRB for detecting MRA and reacting accordingly that may be integrated in ML based system/service to make it MRA resistant. Some embodiments may provide a hardware architecture for integrating the MRB into the ML/DL based technology. The architecture including the MRB may advantageously provide tools for protecting against MRA in ML/DL systems and may make ML as a service (MLaaS) more secure. The model provider may create the training/reversing patterns per product and use case. Some embodiments may implement all or portions of the MRB with a hardware level of protection (e.g., leveraging SGX or other TEE).

Some embodiments may advantageously inhibit MRA from simulating the right distribution of classes because the attacker must train their clone with essentially the full training set including various classes that aren't so frequent in regular queries. On short sequences any violation from distribution is possible, but on long sequences MRA activity would be averaged with regular activity. In some embodiments, the MRB may run concurrently several anomaly detectors based on various accumulation time periods. The MRB log will aggregate a virtually infinite number of the query records and allow post-processing of any subset covering various periods. An attacker trying to hide cloning related attack queries within regular queries traffic will introduce significant delays. For example, a MRB anomaly sample may allow for class A to appear 10 times in three months. Assuming class A (e.g., an anomaly class that is rarely appearing) appears in the training set 30 times (e.g., out of a data set of 1000000), to generate ground-truth for those thirty items, the attack would have to last about 9 months. Because a typical model (e.g. AI as a service (AIaaS) or MLaaS supported by the cloud provider) goes through periodic and frequent re-trainings that may change the model significantly, some embodiments may make attacks spread in time difficult or virtually impossible. Collected responses will become inconsistent and will bring the clone to significant loss of accuracy.

Some embodiments of a MRB may be trained or refined on an actual usage pattern. For a relatively static environment, some embodiments of an inference system may support two phases of activation. During the first phase, the learning system will aggregate data allowing the system to create a sample of the regular query distribution. The system owner/administrator may then switch the system to an operating mode after validating the learned sample in the first phase. Once in the operating mode, the MRB will compare query traffic pattern with the regular pattern to detect anomalies.

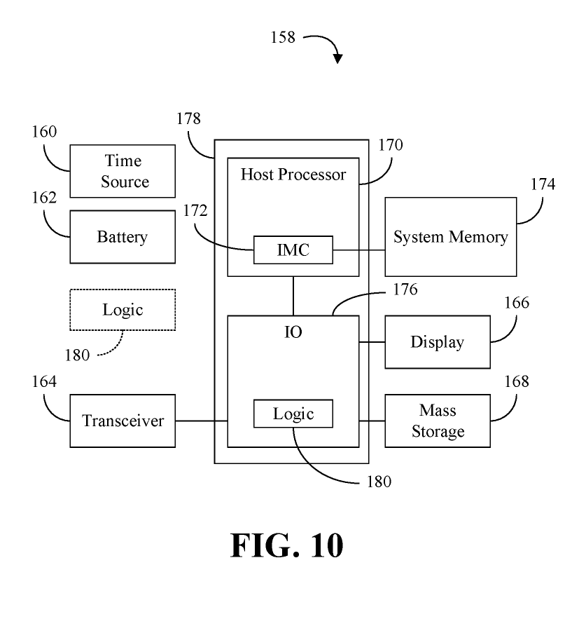

FIG. 10 shows a computing device 158 that may be readily substituted for one or more of the system 10 (FIG. 1), the system 70 (FIG. 7), and/or the inference engine 80 (FIG. 8), already discussed (e.g., or which may incorporate one or more aspects of the embodiments of the apparatus 20 (FIG. 2), the method 30 (FIGS. 3A to 3C), and/or the method 90 (FIG. 9)). In the illustrated example, the device 158 includes a time source 160 (e.g., crystal oscillator, clock), a battery 162 to supply power to the device 158, a transceiver 164 (e.g., wireless or wired), a display 166 and mass storage 168 (e.g., hard disk drive/HDD, solid state disk/SSD, optical disk, flash memory). The device 158 may also include a host processor 170 (e.g., CPU) having an integrated memory controller (IMC) 172, which may communicate with system memory 174. The system memory 174 may include, for example, dynamic random access memory (DRAM) configured as one or more memory modules such as, for example, dual inline memory modules (DIMMs), small outline DIMMs (SODIMMs), etc. The illustrated device 158 also includes an input output (10) module 176 implemented together with the processor 170 on a semiconductor die 178 as a system on chip (SoC), wherein the IO module 176 functions as a host device and may communicate with, for example, the display 166, the transceiver 164, the mass storage 168, and so forth. The mass storage 168 may include non-volatile memory (NVM) that stores one or more keys (e.g., MAC generation keys, encryption keys).

The IO module 176 may include logic 180 that causes the semiconductor die 178 to operate as a model retrieval blocker apparatus such as, for example, the MRB 12 (FIG. 1), the apparatus 20 (FIG. 2), and/or the MRB 72 (FIG. 7) (e.g., or which may incorporate one or more aspects of the flow enforcer 81 (FIG. 8). Thus, the logic 180 may perform run-time analysis of inputs and outputs of a machine learning model of an inference engine, detect an activity indicative of an attempt to retrieve the machine learning model based on the run-time analysis, and perform one or more preventive actions upon detection of the activity indicative of the attempted model retrieval. In some embodiments, the logic 180 may be further configured to run one or more of an activity detection and a preventive action at least partly in a secure execution environment. In some embodiments, the logic 180 may be configured to detect an anomaly related to the usage of the machine learning model. For example, the usage anomaly may be based on one or more of similarities between a model retrieval querying pattern and a training pattern, differences in stochastic distributions between feature sets in training and an inference data set, and differences between statistical distributions of the classifications between training data sets and the inference data set. In some embodiments, the logic 180 may also be configured to enforce flow at one or more flow enforcement points in the machine learning model based on a detected anomaly. For example, the one or more preventive actions may include one or more of an interruption of the flow of the machine learning model, an introduction of delay in the execution of the machine learning model, a modification of outputs of the machine learning model, a creation of a log of information related to the model retrieval attempt, and a notification of the model retrieval attempt. In one example, the time source 160 is autonomous/independent from the controller in order to enhance security (e.g., to prevent the controller from tampering with cadence, frequency, latency and/or timestamp data). The logic 180 may also be implemented elsewhere in the device 158.

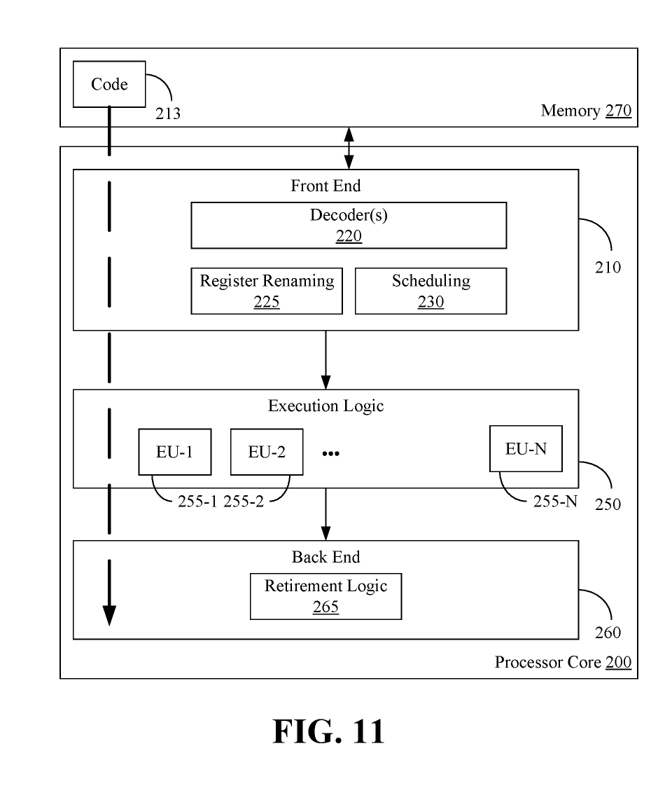

FIG. 11 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 11, a processing element may alternatively include more than one of the processor core 200 illustrated in FIG. 11. The processor core 200 may be a single-threaded core or, for at least one embodiment, the processor core 200 may be multithreaded in that it may include more than one hardware thread context (or “logical processor”) per core.

FIG. 11 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement the method 30 (FIGS. 3A to 3C) and/or the method 90 (FIG. 9), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 11, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

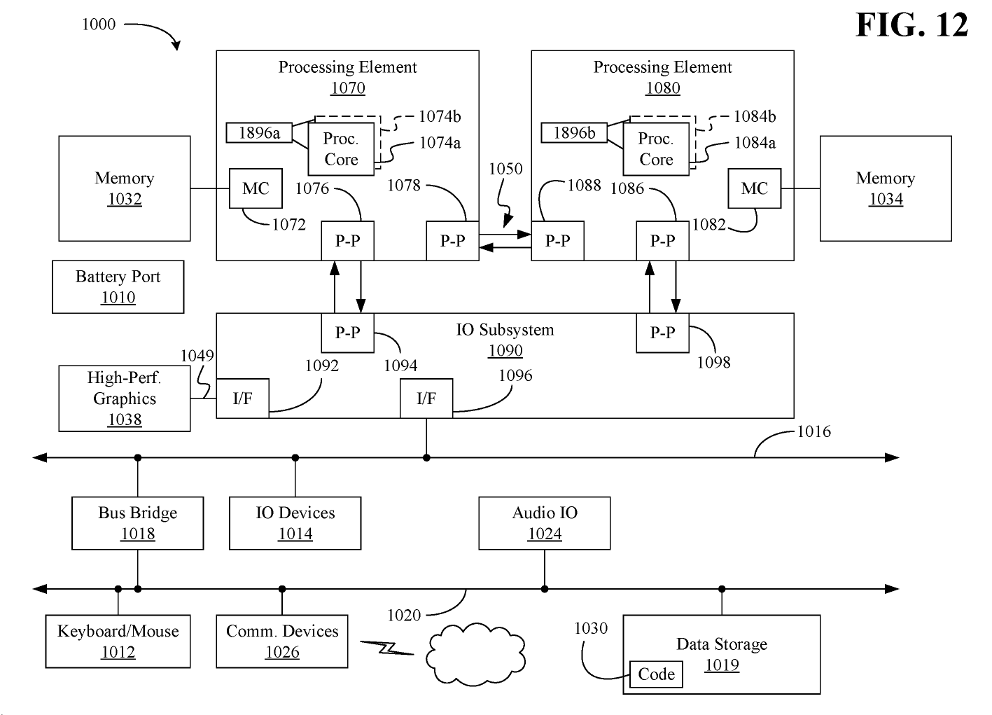

Referring now to FIG. 12, shown is a block diagram of a computing system 1000 embodiment in accordance with an embodiment. Shown in FIG. 12 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 12 may be implemented as a multi-drop bus rather than point-to-point interconnect.

As shown in FIG. 12, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 11.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 12, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 12, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments is not so limited.

As shown in FIG. 12, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 30 (FIGS. 3A to 3C) and/or the method 90 (FIG. 9), already discussed, and may be similar to the code 213 (FIG. 11), already discussed. Further, an audio I/O 1024 may be coupled to second bus 1020 and a battery port 1010 may supply power to the computing system 1000.

Note that other embodiments are contemplated. For example, instead of the point-to-point architecture of FIG. 12, a system may implement a multi-drop bus or another such communication topology. Also, the elements of FIG. 12 may alternatively be partitioned using more or fewer integrated chips than shown in FIG. 12.

### ADDITIONAL NOTES AND EXAMPLES

Example 1 may include an electronic processing system, comprising an inference engine, and a model retrieval blocker communicatively coupled to the inference engine, the model retrieval blocker including logic to perform run-time analysis of inputs and outputs of a machine learning model of the inference engine, detect an activity indicative of an attempt to retrieve the machine learning model based on the run-time analysis, and perform one or more preventive actions upon detection of the activity indicative of the attempted model retrieval.

Example 2 may include the system of Example 1, wherein the logic is further to run one or more of an activity detection and a preventive action at least partly in a secure execution environment.

Example 3 may include the system of Example 1, wherein the logic is further to detect an anomaly related to the usage of the machine learning model.

Example 4 may include the system of Example 3, wherein the usage anomaly is based on one or more of similarities between a model retrieval querying pattern and a training pattern, differences in stochastic distributions between feature sets in training and an inference data set, and differences between statistical distributions of the classifications between training data sets and the inference data set.

Example 5 may include the system of any of Examples 1 to 4, wherein the logic is further to enforce flow at one or more flow enforcement points in the machine learning model based on a detected anomaly.

Example 6 may include the system of any of Examples 1 to 5, wherein the one or more preventive actions include one or more of an interruption of the flow of the machine learning model, an introduction of delay in the execution of the machine learning model, a modification of outputs of the machine learning model, a creation of a log of information related to the model retrieval attempt, and a notification of the model retrieval attempt.

Example 7 may include a semiconductor package apparatus, comprising one or more substrates, and logic coupled to the one or more substrates, wherein the logic is at least partly implemented in one or more of configurable logic and fixed-functionality hardware logic, the logic coupled to the one or more substrates to perform run-time analysis of inputs and outputs of a machine learning model of an inference engine, detect an activity indicative of an attempt to retrieve the machine learning model based on the run-time analysis, and perform one or more preventive actions upon detection of the activity indicative of the attempted model retrieval.

Example 8 may include the apparatus of Example 7, wherein the logic is further to run one or more of an activity detection and a preventive action at least partly in a secure execution environment.

Example 9 may include the apparatus of Example 7, wherein the logic is further to detect an anomaly related to the usage of the machine learning model.

Example 10 may include the apparatus of Example 9, wherein the usage anomaly is based on one or more of similarities between a model retrieval querying pattern and a training pattern, differences in stochastic distributions between feature sets in training and an inference data set, and differences between statistical distributions of the classifications between training data sets and the inference data set.

Example 11 may include the apparatus of any of Examples 7 to 10, wherein the logic is further to enforce flow at one or more flow enforcement points in the machine learning model based on a detected anomaly.

Example 12 may include the apparatus of any of Examples 7 to 11, wherein the one or more preventive actions include one or more of an interruption of the flow of the machine learning model, an introduction of delay in the execution of the machine learning model, a modification of outputs of the machine learning model, a creation of a log of information related to the model retrieval attempt, and a notification of the model retrieval attempt.

Example 13 may include the apparatus of any of Examples 7 to 12, wherein the logic coupled to the one or more substrates includes transistor channel regions that are positioned within the one or more substrates.

Example 14 may include a method of inhibiting model retrieval, comprising performing run-time analysis of inputs and outputs of a machine learning model of an inference engine, detecting an activity indicative of an attempt to retrieve the machine learning model based on the run-time analysis, and performing one or more preventive actions upon detection of the activity indicative of the attempted model retrieval.

Example 15 may include the method of Example 14, further comprising running one or more of an activity detection and a preventive action at least partly in a secure execution environment.

Example 16 may include the method of Example 14, further comprising detecting an anomaly related to the usage of the machine learning model.

Example 17 may include the method of Example 16, wherein the usage anomaly is based on one or more of similarities between a model retrieval querying pattern and a training pattern, differences in stochastic distributions between feature sets in training and an inference data set, and differences between statistical distributions of the classifications between training data sets and the inference data set.

Example 18 may include the method of any of Examples 14 to 17, further comprising enforcing flow at one or more flow enforcement points in the machine learning model based on a detected anomaly.

Example 19 may include the method of any of Examples 14 to 18, wherein the one or more preventive actions include one or more of an interruption of the flow of the machine learning model, an introduction of delay in the execution of the machine learning model, a modification of outputs of the machine learning model, a creation of a log of information related to the model retrieval attempt, and a notification of the model retrieval attempt.

Example 20 may include at least one computer readable storage medium, comprising a set of instructions, which when executed by a computing device, cause the computing device to perform run-time analysis of inputs and outputs of a machine learning model of an inference engine, detect an activity indicative of an attempt to retrieve the machine learning model based on the run-time analysis, and perform one or more preventive actions upon detection of the activity indicative of the attempted model retrieval.

Example 21 may include the at least one computer readable storage medium of Example 20, comprising a further set of instructions, which when executed by the computing device, cause the computing device to run one or more of an activity detection and a preventive action at least partly in a secure execution environment.

Example 22 may include the at least one computer readable storage medium of Example 20, comprising a further set of instructions, which when executed by the computing device, cause the computing device to detect an anomaly related to the usage of the machine learning model.

Example 23 may include the at least one computer readable storage medium of Example 22, wherein the usage anomaly is based on one or more of similarities between a model retrieval querying pattern and a training pattern, differences in stochastic distributions between feature sets in training and an inference data set, and differences between statistical distributions of the classifications between training data sets and the inference data set.

Example 24 may include the at least one computer readable storage medium of any of Examples 20 to 23, comprising a further set of instructions, which when executed by the computing device, cause the computing device to enforce flow at one or more flow enforcement points in the machine learning model based on a detected anomaly.

Example 25 may include the at least one computer readable storage medium of any of Examples 20 to 24, wherein the one or more preventive actions include one or more of an interruption of the flow of the machine learning model, an introduction of delay in the execution of the machine learning model, a modification of outputs of the machine learning model, a creation of a log of information related to the model retrieval attempt, and a notification of the model retrieval attempt.

Example 26 may include a model retrieval blocker apparatus, comprising means for performing run-time analysis of inputs and outputs of a machine learning model of an inference engine, means for detecting an activity indicative of an attempt to retrieve the machine learning model based on the run-time analysis, and means for performing one or more preventive actions upon detection of the activity indicative of the attempted model retrieval.

Example 27 may include the apparatus of Example 26, further comprising means for running one or more of an activity detection and a preventive action at least partly in a secure execution environment.

Example 28 may include the apparatus of Example 26, further comprising means for detecting an anomaly related to the usage of the machine learning model.

Example 29 may include the apparatus of Example 28, wherein the usage anomaly is based on one or more of similarities between a model retrieval querying pattern and a training pattern, differences in stochastic distributions between feature sets in training and an inference data set, and differences between statistical distributions of the classifications between training data sets and the inference data set.

Example 30 may include the apparatus of any of Examples 26 to 29, further comprising means for enforcing flow at one or more flow enforcement points in the machine learning model based on a detected anomaly.

Example 31 may include the apparatus of any of Examples 26 to 30, wherein the one or more preventive actions include one or more of an interruption of the flow of the machine learning model, an introduction of delay in the execution of the machine learning model, a modification of outputs of the machine learning model, a creation of a log of information related to the model retrieval attempt, and a notification of the model retrieval attempt.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, and C” and the phrase “one or more of A, B, or C” both may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. An electronic processing system, comprising:
an inference engine; and
a model retrieval blocker communicatively coupled to the inference engine, the model retrieval blocker including logic to:
perform run-time analysis of inputs and outputs of a machine learning model of the inference engine,
detect an activity indicative of an attempt to retrieve the machine learning model based on the run-time analysis, and
perform one or more preventive actions upon detection of the activity indicative of the attempted model retrieval.

2. The system of claim 1, wherein the logic is further to:
run one or more of an activity detection and a preventive action at least partly in a secure execution environment.

3. The system of claim 1, wherein the logic is further to:
detect an anomaly related to the usage of the machine learning model.

4. The system of claim 3, wherein the usage anomaly is based on one or more of similarities between a model retrieval querying pattern and a training pattern, differences in stochastic distributions between feature sets in training and an inference data set, and differences between statistical distributions of the classifications between training data sets and the inference data set.

5. The system of claim 3, wherein the logic is further to:
enforce flow at one or more flow enforcement points in the machine learning model based on a detected anomaly.

6. The system of claim 1, wherein the one or more preventive actions include one or more of an interruption of the flow of the machine learning model, an introduction of delay in the execution of the machine learning model, a modification of outputs of the machine learning model, a creation of a log of information related to the model retrieval attempt, and a notification of the model retrieval attempt.

7. A semiconductor package apparatus, comprising:
one or more substrates; and
logic coupled to the one or more substrates, wherein the logic is at least partly implemented in one or more of configurable logic and fixed-functionality hardware logic, the logic coupled to the one or more substrates to:
perform run-time analysis of inputs and outputs of a machine learning model of an inference engine,
detect an activity indicative of an attempt to retrieve the machine learning model based on the run-time analysis, and
perform one or more preventive actions upon detection of the activity indicative of the attempted model retrieval.

8. The apparatus of claim 7, wherein the logic is further to:
run one or more of an activity detection and a preventive action at least partly in a secure execution environment.

9. The apparatus of claim 7, wherein the logic is further to:
detect an anomaly related to the usage of the machine learning model.

10. The apparatus of claim 9, wherein the usage anomaly is based on one or more of similarities between a model retrieval querying pattern and a training pattern, differences in stochastic distributions between feature sets in training and an inference data set, and differences between statistical distributions of the classifications between training data sets and the inference data set.

11. The apparatus of claim 9, wherein the logic is further to:
enforce flow at one or more flow enforcement points in the machine learning model based on a detected anomaly.

12. The apparatus of claim 7, wherein the one or more preventive actions include one or more of an interruption of the flow of the machine learning model, an introduction of delay in the execution of the machine learning model, a modification of outputs of the machine learning model, a creation of a log of information related to the model retrieval attempt, and a notification of the model retrieval attempt.

13. The apparatus of claim 7, wherein the logic coupled to the one or more substrates includes transistor channel regions that are positioned within the one or more substrates.

14. A method of inhibiting model retrieval, comprising:
performing run-time analysis of inputs and outputs of a machine learning model of an inference engine;
detecting an activity indicative of an attempt to retrieve the machine learning model based on the run-time analysis; and
performing one or more preventive actions upon detection of the activity indicative of the attempted model retrieval.

15. The method of claim 14, further comprising:
running one or more of an activity detection and a preventive action at least partly in a secure execution environment.

16. The method of claim 14, further comprising:
detecting an anomaly related to the usage of the machine learning model.

17. The method of claim 16, wherein the usage anomaly is based on one or more of similarities between a model retrieval querying pattern and a training pattern, differences in stochastic distributions between feature sets in training and an inference data set, and differences between statistical distributions of the classifications between training data sets and the inference data set.

18. The method of claim 16, further comprising:
enforcing flow at one or more flow enforcement points in the machine learning model based on a detected anomaly.

19. The method of claim 14, wherein the one or more preventive actions include one or more of an interruption of the flow of the machine learning model, an introduction of delay in the execution of the machine learning model, a modification of outputs of the machine learning model, a creation of a log of information related to the model retrieval attempt, and a notification of the model retrieval attempt.

20. At least one computer readable storage medium, comprising a set of instructions, which when executed by a computing device, cause the computing device to:
perform run-time analysis of inputs and outputs of a machine learning model of an inference engine;
detect an activity indicative of an attempt to retrieve the machine learning model based on the run-time analysis; and
perform one or more preventive actions upon detection of the activity indicative of the attempted model retrieval.

21. The at least one computer readable storage medium of claim 20, comprising a further set of instructions, which when executed by the computing device, cause the computing device to:
run one or more of an activity detection and a preventive action at least partly in a secure execution environment.

22. The at least one computer readable storage medium of claim 20, comprising a further set of instructions, which when executed by the computing device, cause the computing device to:
detect an anomaly related to the usage of the machine learning model.

23. The at least one computer readable storage medium of claim 22, wherein the usage anomaly is based on one or more of similarities between a model retrieval querying pattern and a training pattern, differences in stochastic distributions between feature sets in training and an inference data set, and differences between statistical distributions of the classifications between training data sets and the inference data set.

24. The at least one computer readable storage medium of claim 22, comprising a further set of instructions, which when executed by the computing device, cause the computing device to:
enforce flow at one or more flow enforcement points in the machine learning model based on a detected anomaly.

25. The at least one computer readable storage medium of claim 20, wherein the one or more preventive actions include one or more of an interruption of the flow of the machine learning model, an introduction of delay in the execution of the machine learning model, a modification of outputs of the machine learning model, a creation of a log of information related to the model retrieval attempt, and a notification of the model retrieval attempt.
